(19) United States
(12) Patent Application Publication
(10) Pub. No.: US 2014/0279401 A1
(43) Pub. Date: Sep. 18, 2014

(54) SYSTEM AND METHOD FOR ANALYZING INSURANCE-RELATED DATA AND CREDIT-RELATED DATA

(71) Applicant: TRANS UNION LLC, Chicago, IL (US)

(72) Inventors: Jeffrey Martin, Streamwood, IL (US); Matthew Jorge, Chicago, IL (US); James Leuer, Glen Ellyn, IL (US); Ryan Boyle, Wilmette, IL (US); Jeff Reynolds, Winnetka, IL (US); Adam Pichon, Milton, GA (US); Clifton Burns, Geneva, IL (US)

(21) Appl. No.: 14/214,218

(22) Filed: Mar. 14, 2014

Related U.S. Application Data
(60) Provisional application No. 61/799,104, filed on Mar. 15, 2013.

(51) Int. Cl. G06Q 40/02

(52) U.S. Cl. CPC G06Q 40/025
USPC 705/38

(57) ABSTRACT

A system and method is provided for acquiring and storing insurance-related data, such as insurance payment data, insurance coverage data, and insurance claim data, in a credit data database, coverage data database, and/or claim data database, and analyzing for the creditworthiness of an individual based on the insurance-related data and credit-related data. A credit data record of an individual may be determined, based on received insurance-related data. The insurance-related data may be stored in the credit data database, the coverage data database, and/or the claim data database. In response to a request for a credit risk analysis, the credit-related data and insurance-related data can be retrieved and the credit risk analysis can be performed. Customers can obtain an improved and more accurate risk assessment of the individual based on the credit-related data and insurance-related data related to the individual.

### CROSS REFERENCE TO RELATED APPLICATION

This application claims the benefit of U.S. Provisional Patent Application No. 61/799,104 filed on Mar. 15, 2013, which is incorporated herein by reference in its entirety.

### TECHNICAL FIELD

This invention relates to a system and method for the analysis of insurance-related data and credit-related data. More particularly, the invention provides a system and method for acquiring and storing insurance-related data, such as insurance payment data, insurance coverage data, and insurance claim data, in a credit data database, and analyzing for the creditworthiness of an individual based on the insurance-related data and credit-related data.

### BACKGROUND OF THE INVENTION

The consumer lending industry bases its decisions to grant credit or make loans, or to give consumers preferred credit or loan terms, on the general principle of risk, i.e., risk of delinquency. Credit and lending institutions typically avoid granting credit or loans to high risk consumers, or may grant credit or lending to such consumers at higher interest rates or other terms less favorable than those typically granted to consumers with low risk. Consumer credit data, including consumer credit information, is collected and used by credit bureaus, financial institutions, and other entities for assessing creditworthiness and aspects of a consumer's financial and credit history. Credit scores that are numerical approximations of risk associated with consumers may be generated based on a consumer's credit information and history. Credit scores may assist in assessing a consumer's credit.

Consumer credit data typically includes information such as indicative data to identify the consumer and financial data related to trade lines, e.g., lines of credit, such as the status of debt repayment, on-time payment records, etc. The financial data is often received from financial institutions, such as banks, credit unions, and savings and loan institutions; credit card issuers; and similar entities that grant credit or loans, for example. The historical aspects of the financial data are often utilized by entities to determine whether to grant credit or loans to a consumer. For example, if an individual wants to obtain a loan from a bank, the bank can retrieve the credit report of the individual to assist in making a decision on whether to grant the loan to the individual. The bank may grant a loan to an individual who has timely repaid their debts, but may not grant a loan to an individual who has missed payments.

However, typical financial data that is collected by credit bureaus does not include information such as payment data, coverage data, and claim data related to insurance policies obtained by consumers. A particular insurance company may utilize such information internally for its customers, but other entities, such as financial institutions, generally do not have access to this information. As such, the assessment of a consumer's creditworthiness may not be optimal because the consumer's insurance payment data, insurance coverage data, and insurance claim data are not factored into these types of decisions.

Therefore, there exists an opportunity for a system and method that can acquire and store insurance-related data, such as insurance payment data, insurance coverage data, and insurance claim data, in a credit data database, coverage data database, and/or claim data database, and analyze for the creditworthiness of an individual based on the insurance-related data and credit-related data, in order to, among other things, obtain improved and more accurate risk assessments of individuals.

### SUMMARY OF THE INVENTION

The invention is intended to solve the above-noted problems by providing systems and methods for analyzing for the creditworthiness of an individual by acquiring and storing insurance-related data in a credit data record of the individual, a coverage data record of the individual, and/or a claim data record of the individual, and performing a credit risk analysis based on the insurance-related data and the credit-related data. The systems and methods are designed to, among other things: (1) receive insurance-related data for an individual, including insurance payment data, insurance coverage data, and/or insurance claim data; (2) determine a credit data record of the individual, based on the insurance payment data, the insurance coverage data, and/or the insurance claim data; (3) store the insurance payment data, the insurance coverage data, and/or the insurance claim data in one or more databases; and (4) perform and provide a credit risk analysis based on the insurance-related data and credit-related data related to the individual.

In a particular embodiment, insurance-related data includes insurance payment data related to an individual and insurance coverage data and insurance claim data related to the individual and/or assets. The insurance payment data may be received from an insurance payment data source, the insurance coverage data may be received from an insurance coverage data source, and the insurance claim data may be received from an insurance claim data source. The credit data record of the individual may be determined in the credit data database, based on the insurance payment data, the insurance coverage data, and/or the insurance claim data. The insurance payment data may be stored in the credit data database, the insurance coverage data may be stored in a coverage data database, and/or the insurance claim data may be stored in a claim data database. A request may be received for a credit risk analysis involving the credit-related data and the insurance-related data related to an individual. The credit data record of the individual may be retrieved from the credit data database, the coverage data record of the individual may be retrieved from the coverage data database, and/or the claim data record may be retrieved from the claim data database. The credit risk analysis may be performed to generate analytic data, based on the insurance-related data and the credit-related data. The analytic data may be transmitted.

These and other embodiments, and various permutations and aspects, will become apparent and be more fully understood from the following detailed description and accompanying drawings, which set forth illustrative embodiments that are indicative of the various ways in which the principles of the invention may be employed.

### BRIEF DESCRIPTION OF THE DRAWINGS

FIG. 1 is a block diagram illustrating a system for acquiring, storing, and analyzing insurance-related data and credit-related data related to an individual.

FIG. 2 is a block diagram of one form of a computer or server of FIG. 1, having a memory element with a computer readable medium for implementing the system for analyzing insurance-related data and credit-related data related to an individual.

FIG. 3 is a flowchart illustrating operations for acquiring, storing, and analyzing insurance-related data and credit-related data related to an individual using the system of FIG. 1.

### DETAILED DESCRIPTION OF THE INVENTION

The description that follows describes, illustrates and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the specification is intended to be taken as a whole and interpreted in accordance with the principles of the invention as taught herein and understood to one of ordinary skill in the art.

It should also be noted that the disclosures made in this specification are in accordance with the principles of the embodiments(s), which are intended to be disclosed or interpreted to their broadest extent under the patent laws, and while such disclosure may describe or otherwise cover subject matter that may be regulated by other existing laws or regulations, including, without limitation, the Fair Credit Reporting Act (FCRA), the Equal Credit Opportunity Act (ECOA), or regulations promulgated by state departments of insurance, nothing in this disclosure is intended to suggest or imply noncompliance with any such law or regulation by the assignee.

FIG. 1 illustrates an insurance-related data and credit-related data analysis system 100 for acquiring, storing, and analyzing insurance-related data and credit-related data related to an individual, in accordance with one or more principles of the invention. The system 100 may acquire insurance payment data for an individual from an insurance payment data source 150, insurance coverage data for the individual and/or an asset (e.g., an insured automobile, property, etc.) from an insurance coverage data source 152, and/or insurance claim data for the individual and/or the asset from an insurance claim data source 153. The system 100 may also determine a matching credit data record of the individual in a credit data database 104; store the insurance payment data in the credit data database 104, the insurance coverage data in a coverage data database 105, and the insurance claim data in a claim data database 107; and perform a credit risk analysis and provide the analytic data to a customer 154 based on the insurance-related data and credit-related data related to the individual. Accordingly, the customers 154, such as financial institutions, insurance companies, utility companies, and the like, can obtain improved and more accurate risk assessments of individuals based on the insurance-related data and credit-related data related to the individuals. Various components of the system 100 may be implemented using software executable by one or more servers or computers, such as a computing device 200 with a processor 202 and memory 204 as shown in FIG. 2, which is described in more detail below.

In an embodiment, an insurance information acquisition engine 102 in the system 100 may receive insurance-related data from one or more sources. The insurance-related data may include insurance payment data for one or more individuals from an insurance payment data source 150, insurance coverage data for one or more individuals from an insurance coverage data source 152, and/or insurance claim data for one or more individuals from an insurance claim data source 153. The insurance-related data may include information associated with one or more policies that the individuals have with an insurance company. The policies may be related to homeowners insurance, condominium insurance, automobile insurance, specialty insurance (e.g., for motorcycles, recreational vehicles, boats, etc.), renters insurance, landlord insurance, life insurance, health insurance, flood insurance, and other types of insurance, for example.

In particular, insurance payment data may include identifying information of one or more individuals covered by the policy (e.g., name, address, phone number, date of birth, social security number, etc.), an insurance company name, an account or policy number, a kind of business code, an opening/effective account or policy date, an update account or policy date, a closing/expiration account or policy date, an insurance type (e.g., homeowners, automobile, etc.), a payment amount, a payment frequency (e.g., how often the individual needs to make a payment), and/or a payment pattern (e.g., historical payment status indicating whether a payment was current, late, resulted in a pending cancellation, resulted in a cancellation, or resulted in a reinstatement). Insurance coverage data may include identifying information of an individual (e.g., name, address, phone number, date of birth, social security number, drivers license number, etc.), identifying information of authorized individuals (e.g., additional drivers, spouse, dependents, etc.), an insurance company name, an account or policy number, an insurance type (e.g., homeowners, automobile, etc.), effective and expiration dates, a coverage type (e.g., collision, comprehensive, flood, liability, windstorm, medical, etc.), insured assets, a coverage limit, a deductible amount, and/or a discount amount. Insurance claim data may include identifying information of an individual (e.g., name, address, phone number, date of birth, social security number, drivers license number, etc.), an insurance company name, an account or policy number, an insurance type (e.g., homeowners, automobile, etc.), a classification of a claim, a severity of the claim, a date of the claim, a claimed amount, and/or a payout amount. Each of the insurance payment data source 150, the insurance coverage data source 152, and the insurance claim data source 153 may be an insurance company, a general agency, a data aggregator, and/or another source.

Based on the insurance payment data, the insurance coverage data, and/or the insurance claim data, the insurance information acquisition engine 102 may determine a credit data record of an individual in the credit data database 104. In one embodiment, indicative information in the credit data record, such as credit header data, may be compared to the indicative information (e.g., identifying information for the individual) present in the insurance payment data, the insurance coverage data, and/or the insurance claim data. For example, the insurance payment data, the insurance coverage data, and the insurance claim data may include the name, address, and date of birth of the individual who is the policyholder of an insurance policy. The insurance information acquisition engine 102 may compare this information to indicative information in the credit data records of the credit data database 104 to determine the specific credit data record of a particular individual in the credit data database 104.

In other embodiments, non-indicative information to uniquely identify an individual or an account/policy in the credit data record, the insurance payment data, the insurance coverage data, and/or the insurance claim data may be compared in addition to or instead of the indicative information. The non-indicative information may include, for example, account/policy numbers, dates of policies, phone numbers, vehicle identification numbers (VINs), etc. For example, the VIN may be present in the insurance payment data and the insurance claim data, but only the insurance payment data includes indicative information for a particular individual. In this case, the VIN may link the insurance claim data and the insurance payment data so that the insurance claim data is identified as related to the particular individual. The indicative data in the insurance payment data may then be used to determine the specific credit data record of the particular individual in the credit data database 104.

In some embodiments, while the insurance payment data, the insurance coverage data, and the insurance claim data may be from the same entity, the raw format of the files including the insurance payment data, the insurance coverage data, and the insurance claim data may not be suitable for addition to the credit data database 104, the coverage data database 105, and/or the claim data database 107. As such, the insurance information acquisition engine 102 may perform transformation operations on the insurance-related data. Such transformation operations may include normalizing the insurance-related data to a consistent format, e.g., expanding abbreviations, converting dates, etc. The transformation operations may assist in converting raw data from the sources into a suitable format for storage in the credit data database 104, the coverage data database 105, and/or the claim data database 107. The transformation operations may also ease matching of the insurance-related data to the credit data records.

Once the specific credit data record of the individual is determined, the insurance payment data, the insurance coverage data, and/or the insurance claim data may be stored in the credit data database 104, the coverage data database 105, and/or the claim data database 107 by the insurance information acquisition engine 102 in the credit data record, coverage data record, and/or claim data record of the individual. In some embodiments, the insurance payment data, the insurance coverage data, and/or the insurance claim data may be applicable to multiple individuals, e.g., members of the same household. In this case, the insurance payment data, the insurance coverage data, and/or the insurance claim data may be stored in the credit data database 104, the coverage data database 105, and/or the claim data database 107 by the insurance information acquisition engine 102 in each individual's respective credit data record, coverage data record, and/or claim data record.

In embodiments, the insurance payment data, the insurance coverage data, and/or the insurance claim data may be stored in a separate data store associated with credit data. In some embodiments, transformed insurance payment data, transformed insurance coverage data, and/or transformed insurance claim data may be stored by the insurance information acquisition engine 102 in the credit data record, coverage data record, and/or claim data record of the individual in the credit data database 104, coverage data database 105, and/or claim data database 107. In one embodiment, the insurance information acquisition engine 102 may add the insurance-related data to the existing credit-related data in the credit data record, the coverage data record, and/or the claim data record. In other embodiments, the insurance information acquisition engine 102 may update existing insurance-related data in the credit data record, the coverage data record, and/or the claim data record with the newly-received insurance-related data. In some embodiments, the insurance information acquisition engine 102 may use the newly-received insurance-related data to create new credit data records, coverage data records, and/or claim data records for individuals who have not matched any records in the credit data database 104.

In embodiments, not all of the insurance-related data may be added to the credit data record of the individual. For example, the insurance payment data and a portion of the insurance coverage data, e.g., basic coverage information such as the policy status, start and end dates of the policy, and the individuals covered by the policy, may be added to the credit data record and/or coverage data record of the individual in the credit data database 104 and/or coverage data database 105. Other portions of the insurance coverage data, e.g., detailed coverage information such as the policy coverage limit and the insured assets covered by the policy (automobiles, buildings, etc.), may be stored in the insurance coverage database 105 and be linked to the credit data record of the individual in the credit data database 104. As another example, a portion of the insurance claim data may be added to the credit data record of the individual in the credit data database 104, and other portions of the insurance claim data may be stored in the insurance claim database 107 and be linked to the credit data record of the individual in the credit data database 104.

An analysis engine 106 of the insurance-related data and credit-related data analysis system 100 may receive a request from a customer 154 for a credit risk analysis involving the insurance-related data and the credit-related data related to an individual. The customer 154 may be a financial institution, an insurance company, a utility company, and/or another entity that wants a risk assessment of the individual, for example. The credit risk analysis may include, for example, retrieving a credit report of the individual, generating a risk score for the individual, performing a marketing prescreen of the individual, performing a risk assessment of the individual, generating a credit decision, generating an insurance underwriting decision, validating prior insurance coverage, retrieving the limits of prior insurance coverage, risk assessments related to asset information, and/or other functions.

The analysis engine 106 may retrieve the credit data record of the individual associated with the analysis request from the credit data database 104, the coverage data record of the individual associated with the analysis request from the coverage data database 105, and/or the claim data record of the individual associated with the analysis request from the claim data database 107. Based on the insurance-related data and/or the credit-related data in the credit data record, coverage data record, and/or claim data record, the analysis engine 106 may perform the credit risk analysis to generate analytic data, and provide the analytic data to the customer 154. Some or all of the insurance-related data and none, some, or all of the credit-related data may be factored into the credit risk analysis. In some embodiments, the existence or non-existence of particular insurance-related data and/or credit-related data may factor into the credit risk analysis. The analysis engine 106 may provide and transmit the analytic data in a text format, XML format, and/or other appropriate format, for example. As examples, the analytic data may include separate attributes (e.g., the number of tradelines the individual has), and/or may be a risk score that aggregates such attributes.

FIG. 2 is a block diagram of a computing device 200 housing executable software used to facilitate the insurance-related data and credit-related data analysis system 100. One or more instances of the computing device 200 may be utilized to implement any, some, or all of the components in the system 100, including the insurance information acquisition engine 102 and the analysis engine 106. Computing device 200 includes a memory element 204. Memory element 204 may include a computer readable medium for implementing the system 100, and for implementing particular system transactions. Memory element 204 may also be utilized to implement the credit data database 104, the coverage data database 105, and the claim data database 107. Computing device 200 also contains executable software, some of which may or may not be unique to the system 100.

In some embodiments, the system 100 is implemented in software, as an executable program, and is executed by one or more special or general purpose digital computer(s), such as a mainframe computer, a personal computer (desktop, laptop or otherwise), personal digital assistant, or other handheld computing device. Therefore, computing device 200 may be representative of any computer in which the system 100 resides or partially resides.

Generally, in terms of hardware architecture as shown in FIG. 2, computing device 200 includes a processor 202, a memory 204, and one or more input and/or output (I/O) devices 206 (or peripherals) that are communicatively coupled via a local interface 208. Local interface 208 may be one or more buses or other wired or wireless connections, as is known in the art. Local interface 208 may have additional elements, which are omitted for simplicity, such as controllers, buffers (caches), drivers, transmitters, and receivers to facilitate external communications with other like or dissimilar computing devices. Further, local interface 208 may include address, control, and/or data connections to enable internal communications among the other computer components.

Processor 202 is a hardware device for executing software, particularly software stored in memory 204. Processor 202 can be any custom made or commercially available processor, such as, for example, a Core series or vPro processor made by Intel Corporation, or a Phenom, Athlon or Sempron processor made by Advanced Micro Devices, Inc. In the case where computing device 200 is a server, the processor may be, for example, a Xeon or Itanium processor from Intel, or an Opteron-series processor from Advanced Micro Devices, Inc. Processor 202 may also represent multiple parallel or distributed processors working in unison.

Memory 204 can include any one or a combination of volatile memory elements (e.g., random access memory (RAM, such as DRAM, SRAM, SDRAM, etc.)) and nonvolatile memory elements (e.g., ROM, hard drive, flash drive, CDROM, etc.). It may incorporate electronic, magnetic, optical, and/or other types of storage media. Memory 204 can have a distributed architecture where various components are situated remote from one another, but are still accessed by processor 202. These other components may reside on devices located elsewhere on a network or in a cloud arrangement.

The software in memory 204 may include one or more separate programs. The separate programs comprise ordered listings of executable instructions for implementing logical functions. In the example of FIG. 2, the software in memory 204 may include the system 100 in accordance with the invention, and a suitable operating system (O/S) 212. Examples of suitable commercially available operating systems 212 are Windows operating systems available from Microsoft Corporation, Mac OS X available from Apple Computer, Inc., a Unix operating system from AT&T, or a Unix-derivative such as BSD or Linux. The operating system O/S 212 will depend on the type of computing device 200. For example, if the computing device 200 is a PDA or handheld computer, the operating system 212 may be iOS for operating certain devices from Apple Computer, Inc., PalmOS for devices from Palm Computing, Inc., Windows Phone 8 from Microsoft Corporation, Android from Google, Inc., or Symbian from Nokia Corporation. Operating system 212 essentially controls the execution of other computer programs, such as the system 100, and provides scheduling, input-output control, file and data management, memory management, and communication control and related services.

If computing device 200 is an IBM PC compatible computer or the like, the software in memory 204 may further include a basic input output system (BIOS). The BIOS is a set of essential software routines that initialize and test hardware at startup, start operating system 212, and support the transfer of data among the hardware devices. The BIOS is stored in ROM so that the BIOS can be executed when computing device 200 is activated.

Steps and/or elements, and/or portions thereof of the invention may be implemented using a source program, executable program (object code), script, or any other entity comprising a set of instructions to be performed. Furthermore, the software embodying the invention can be written as (a) an object oriented programming language, which has classes of data and methods, or (b) a procedural programming language, which has routines, subroutines, and/or functions, for example but not limited to, C, C++, C#, Pascal, Basic, Fortran, Cobol, Perl, Java, Ada, Python, and Lua. Components of the system 100 may also be written in a proprietary language developed to interact with these known languages.

I/O device 206 may include input devices such as a keyboard, a mouse, a scanner, a microphone, a touch screen, a bar code reader, or an infra-red reader. It may also include output devices such as a printer, a video display, an audio speaker or headphone port or a projector. I/O device 206 may also comprise devices that communicate with inputs or outputs, such as a short-range transceiver (RFID, Bluetooth, etc.), a telephonic interface, a cellular communication port, a router, or other types of network communication equipment. I/O device 206 may be internal to computing device 200, or may be external and connected wirelessly or via connection cable, such as through a universal serial bus port.

When computing device 200 is in operation, processor 202 is configured to execute software stored within memory 204, to communicate data to and from memory 204, and to generally control operations of computing device 200 pursuant to the software. The system 100 and operating system 212, in whole or in part, may be read by processor 202, buffered within processor 202, and then executed.

In the context of this document, a “computer-readable medium” may be any means that can store, communicate, propagate, or transport data objects for use by or in connection with the system 100. The computer readable medium may be for example, an electronic, magnetic, optical, electromagnetic, infrared, or semiconductor system, apparatus, device, propagation medium, or any other device with similar functionality. More specific examples (a non-exhaustive list) of the computer-readable medium would include the following: an electrical connection (electronic) having one or more wires, a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and stored in a computer memory. The system 100 can be embodied in any type of computer-readable medium for use by or in connection with an instruction execution system or apparatus, such as a computer.

For purposes of connecting to other computing devices, computing device 200 is equipped with network communication equipment and circuitry. In a preferred embodiment, the network communication equipment includes a network card such as an Ethernet card, or a wireless connection card. In a preferred network environment, each of the plurality of computing devices 200 on the network is configured to use the Internet protocol suite (TCP/IP) to communicate with one another. It will be understood, however, that a variety of network protocols could also be employed, such as IEEE 802.11 Wi-Fi, address resolution protocol ARP, spanning-tree protocol STP, or fiber-distributed data interface FDDI. It will also be understood that while a preferred embodiment of the invention is for each computing device 200 to have a broadband or wireless connection to the Internet (such as DSL, Cable, Wireless, T-1, T-3, OC3 or satellite, etc.), the principles of the invention are also practicable with a dialup connection through a standard modem or other connection means. Wireless network connections are also contemplated, such as wireless Ethernet, satellite, infrared, radio frequency, Bluetooth, near field communication, and cellular networks.

An embodiment of a process 300 for acquiring, storing, and analyzing insurance-related data and credit-related data related to an individual is shown in FIG. 3. The process 300 can result in acquiring insurance payment data for an individual from an insurance payment data source, insurance coverage data for the individual and/or an asset from an insurance coverage data source, and/or insurance claim data for the individual and/or the asset from an insurance claim data source. The process 300 may also result in determining a matching credit data record of the individual in a credit data database; storing the insurance payment data in the credit data database, the insurance coverage data in a coverage data database, and the insurance claim data in a claim data database; and performing a credit risk analysis and providing analytic data to a customer based on the insurance-related data and credit-related data related to the individual. Customers using the process 300 can obtain improved and more accurate risk assessments of individuals based on the insurance-related data and credit-related data related to the individuals.

At step 302, insurance payment data may be received from an insurance payment data source. Insurance payment data may include identifying information of one or more individuals covered by the policy (e.g., name, address, phone number, date of birth, social security number, etc.), an insurance company name, an account or policy number, a kind of business code, an opening/effective account or policy date, an update account or policy date, a closing/expiration account or policy date, an insurance type (e.g., homeowners, automobile, etc.), a payment amount, a payment frequency (e.g., how often the individual needs to make a payment), and/or a payment pattern (e.g., historical payment status indicating whether a payment was current, late, resulted in a pending cancellation, resulted in a cancellation, or resulted in a reinstatement). At step 304, insurance coverage data may be received from an insurance coverage data source. Insurance coverage data may include identifying information of an individual (e.g., name, address, phone number, date of birth, social security number, drivers license number, etc.), identifying information of authorized individuals (e.g., additional drivers, spouse, dependents, etc.), an insurance company name, an account or policy number, an insurance type (e.g., homeowners, automobile, etc.), effective and expiration dates, a coverage type (e.g., collision, comprehensive, flood, liability, windstorm, medical, etc.), insured assets, a coverage limit, a deductible amount, and/or a discount amount. Insurance claim data may be received at step 305 from an insurance claim data source. Insurance claim data may include identifying information of an individual (e.g., name, address, phone number, date of birth, social security number, drivers license number, etc.), an insurance company name, an account or policy number, an insurance type (e.g., homeowners, automobile, etc.), a classification of a claim, a severity of the claim, a date of the claim, a claimed amount, and/or a payout amount. Each of the insurance payment data source, the insurance coverage data source, and the insurance claim data source may be an insurance company, a general agency, a data aggregator, and/or another source.

The credit data record of an individual in a credit data database may be determined at step 306, based on the insurance payment data, the insurance coverage data, and/or the insurance claim data. In one embodiment, information in the insurance payment data, the insurance coverage data, and/or the insurance claim data may be compared to indicative information, such as credit header data, and/or non-indicative information in the credit data records. The non-indicative information may uniquely identify an individual or an account/policy, for example. If a matching credit data record is not found at step 308, then process 300 continues to step 320. At step 320, a new credit data record, coverage data record, and/or claim data record may be created in the credit data database, coverage data database, and/or claim data database, based on the indicative information and non-indicative information included in the newly-received insurance-related data. Following step 320, the process 300 may continue to step 312, as described below.

However, if a matching credit data record is found at step 308, then the process 300 continues to step 310. At step 310, the insurance payment data, the insurance coverage data, and/or the insurance claim data may be stored in the credit data record for the individual in the credit data database, in a coverage data record for the individual in a coverage data database, and/or in a claim data record for the individual in a claim data database. The insurance-related data may be added to the credit-related data already in the credit data record, coverage data record, and/or claim data record, for example, and/or existing insurance-related data may be updated with the new insurance-related data.

A request from a customer may be received at step 312 that requests a credit risk analysis involving the insurance-related data and the credit-related data related to a particular individual. The customer may be a financial institution, an insurance company, a utility company, and/or another entity that wants a risk assessment of the individual, for example. The credit risk analysis may include, for example, retrieving a credit report of the individual, generating a risk score for the individual, performing a marketing prescreen of the individual, performing a risk assessment of the individual, generating a credit decision, generating an insurance underwriting decision, validating prior insurance coverage, retrieving the limits of prior insurance coverage, risk assessments related to asset information, and/or other functions. At step 314, the credit data record of the individual may be retrieved from the credit data database, the coverage data record of the individual may be retrieved from the coverage data database, and/or the claim data record of the individual may be retrieved from the claim data database. Based on the insurance-related data and/or the credit-related data in the credit data record, coverage data record, and/or claim data record, a credit risk analysis may be performed at step 316 to generate analytic data. Some or all of the insurance-related data and none, some, or all of the credit-related data may be factored into the credit risk analysis. At step 318, the analytic data may be provided, e.g., transmitted, to the customer. The analytic data may be provided in a text format, XML format, and/or other appropriate format, for example.

Any process descriptions or blocks in figures should be understood as representing modules, segments, or portions of code which include one or more executable instructions for implementing specific logical functions or steps in the process, and alternate implementations are included within the scope of the embodiments of the invention in which functions may be executed out of order from that shown or discussed, including substantially concurrently or in reverse order, depending on the functionality involved, as would be understood by those having ordinary skill in the art.

It should be emphasized that the above-described embodiments of the invention, particularly, any “preferred” embodiments, are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and the invention and protected by the following claims.

1. A method for analyzing insurance-related data and credit-related data related to an individual, using a processor, the insurance-related data comprising one or more of insurance payment data related to the individual or insurance coverage data related to one or more of the individual and an asset, the method comprising:
receiving one or more of the insurance payment data or the insurance coverage data at the processor;
determining a credit data record of the individual in a credit data database, based on one or more of the insurance payment data or the insurance coverage data, using the processor;
storing one or more of the insurance payment data in the credit data record of the individual in the credit data database, or the insurance coverage data in a coverage data record of the individual in a coverage data database, using the processor;
receiving a request at the processor, the request for a credit risk analysis involving the credit-related data and the insurance-related data related to the individual;
retrieving one or more of the credit data record of the individual from the credit data database or the coverage data record of the individual from the coverage data database, using the processor;
performing the credit risk analysis to generate analytic data using the processor, based on the insurance-related data and the credit-related data in the retrieved credit data record and the coverage data record; and
transmitting the analytic data from the processor.

2. The method of claim 1, wherein determining the credit data record of the individual comprises comparing indicative information in the credit data record of the individual with indicative information in one or more of the insurance payment data or the insurance coverage data, using the processor.

3. The method of claim 1, wherein determining the credit data record of the individual comprises comparing non-indicative information in the credit data record of the individual with non-indicative information in one or more of the insurance payment data or the insurance coverage data, using the processor.

4. The method of claim 1, wherein storing one or more of the insurance payment data or the insurance coverage data comprises:
updating, in the credit data database, one or more of existing insurance payment data or existing insurance coverage data in the credit data record of the individual with one or more of the insurance payment data or the insurance coverage data, using the processor.

5. The method of claim 1, wherein storing one or more of the insurance payment data or the insurance coverage data comprises:
storing the insurance payment data in the credit data record of the individual in the credit data database, using the processor; and
storing the insurance coverage data in the insurance coverage data record of the individual in the coverage data database, using the processor.

6. The method of claim 1, wherein storing one or more of the insurance payment data or the insurance coverage data comprises:
transforming one or more of the insurance payment data or the insurance coverage data to transformed insurance payment data or transformed insurance coverage data, using the processor; and
storing one or more of the transformed insurance payment data in the credit data record of the individual in the credit data database, or the transformed insurance coverage data in the coverage data record of the individual in the coverage data database, using the processor.

7. The method of claim 1, wherein performing the credit risk analysis comprises one or more of retrieving a credit report of the individual, generating a risk score for the individual, performing a marketing prescreen of the individual, performing a risk assessment of the individual, generating a credit decision, generating an insurance underwriting decision, validating prior insurance coverage, or retrieving the limits of prior insurance coverage, using the processor.

8. The method of claim 7, wherein transmitting the analytic data comprises one or more of transmitting from the processor the credit report of the individual, transmitting the risk score for the individual, transmitting data related to the marketing prescreen of the individual, transmitting the risk assessment of the individual, transmitting the credit decision, transmitting the insurance underwriting decision, transmitting data related to validating the prior insurance coverage, or transmitting the limits of prior insurance coverage.

9. The method of claim 1, wherein the insurance payment data comprises one or more of identifying information of the individual, an insurance company name, an account or policy number, a kind of business code, a opening/effective account or policy date, an update account or policy date, a closing/expiration account or policy date, an insurance type, a payment amount, a payment frequency, or a payment pattern.

10. The method of claim 1, wherein the insurance coverage data comprises one or more of identifying information of the individual, identifying information of authorized individuals, an insurance company name, an account or policy number, an insurance type, effective and expiration dates, a coverage type, a coverage limit, a deductible amount, or a discount amount.

11. A system for analyzing insurance-related data and credit-related data related to an individual, the insurance-related data comprising one or more of insurance payment data related to the individual or insurance coverage data related to one or more of the individual and an asset, the system comprising:
a processor in communication with a network;
a memory in communication with the processor, the memory for storing:
a credit data database comprising the credit-related data;
a coverage data database comprising the insurance coverage data;
an insurance information acquisition engine for:
receiving one or more of the insurance payment data or the insurance coverage data;
determining a credit data record of the individual in the credit data database, based on one or more of the insurance payment data or the insurance coverage data; and
storing one or more of the insurance payment data in the credit data record of the individual in the credit data database, or the insurance coverage data in a coverage data record of the individual in the coverage data database; and
an analysis engine for:
receiving a request, the request for a credit risk analysis involving the credit-related data and the insurance-related data related to the individual;
retrieving one or more of the credit data record of the individual from the credit data database, or the coverage data record of the individual from the coverage data database;
performing the credit risk analysis to generate analytic data, based on the insurance-related data and the credit-related data in the retrieved credit data record and the coverage data record; and
transmitting the analytic data.

12. The system of claim 11, wherein the insurance information acquisition engine determines the credit data record of the individual by comparing indicative information in the credit data record of the individual with indicative information in one or more of the insurance payment data or the insurance coverage data.

13. The system of claim 11, wherein the insurance information acquisition engine determines the credit data record of the individual by comparing non-indicative information in the credit data record of the individual with non-indicative information in one or more of the insurance payment data or the insurance coverage data.

14. The system of claim 11, wherein the insurance information acquisition engine stores one or more of the insurance payment data or the insurance coverage data by:
updating, in the credit data database, one or more of existing insurance payment data or existing insurance coverage data in the credit data record of the individual with one or more of the insurance payment data or the insurance coverage data.

15. The system of claim 11, wherein the insurance information acquisition engine stores one or more of the insurance payment data or the insurance coverage data by:
storing the insurance payment data in the credit data record of the individual in the credit data database; and
storing the insurance coverage data in the insurance coverage data record of the individual in the coverage data database.

16. The system of claim 11, wherein the insurance information acquisition engine stores one or more of the insurance payment data or the insurance coverage data by:
transforming one or more of the insurance payment data or the insurance coverage data to transformed insurance payment data or transformed insurance coverage data; and
storing one or more of the transformed insurance payment data in the credit data record of the individual in the credit data database, or the transformed insurance coverage data in the coverage data record of the individual in the coverage data database.

17. The system of claim 11, wherein the analysis engine performs the credit risk analysis by one or more of retrieving a credit report of the individual, generating a risk score for the individual, performing a marketing prescreen of the individual, performing a risk assessment of the individual, generating a credit decision, generating an insurance underwriting decision, validating prior insurance coverage, or retrieving the limits of prior insurance coverage.

18. The system of claim 17, wherein the analysis engine transmits the analytic data by one or more of transmitting the credit report of the individual, transmitting the risk score for the individual, transmitting data related to the marketing prescreen of the individual, transmitting the risk assessment of the individual, transmitting the credit decision, transmitting the insurance underwriting decision, transmitting data related to validating the prior insurance coverage, or transmitting the limits of prior insurance coverage.

19. The system of claim 11, wherein the insurance payment data comprises one or more of identifying information of the individual, an insurance company name, an account or policy number, a kind of business code, a opening/effective account or policy date, an update account or policy date, a closing/expiration account or policy date, an insurance type, a payment amount, a payment frequency, or a payment pattern.

20. The system of claim 11, wherein the insurance coverage data comprises one or more of identifying information of the individual, identifying information of authorized individuals, an insurance company name, an account or policy number, an insurance type, effective and expiration dates, a coverage type, a coverage limit, a deductible amount, or a discount amount.
